(19) United States
(12) Patent Application Publication
(10) Pub. No.: US 2009/0253112 A1
(43) Pub. Date: Oct. 8, 2009

(54) RECOMMENDING QUESTIONS TO USERS OF COMMUNITY QIESTION ANSWERING

(75) Inventors: Yunbo Cao, Beijing (CN); Chin-Yew Lin, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/098,457

(22) Filed: Apr. 7, 2008

(51) Int. Cl. G09B 5/00

(52) U.S. Cl. 434/322

(57) ABSTRACT

The present system graphs topic terms in stored cQA questions and also converts a submitted question into a graph of topic terms. Topic terms that correspond to a question topic are delineated from topic terms that correspond to question focus. New questions are recommended to the user based on a comparison between the topics of the new questions and the topic of the submitted question as well as the focus of the new questions and the focus of the submitted question.

### BACKGROUND

There are many different types of techniques for discovering information, using a computer network. One specific technique is referred to as a community-based question and answering service (referred to as cQA services). The cQA service is a kind of web service through which people can post questions and also post answers to other peoples' questions on a web site. The growth of cQA has been relatively significant, and it has recently been offered by commercially available web search engines.

In current cQA services, a community of users either subscribes to the service, or simply accesses the service through a network. The users in the community can post questions that are viewable by other users in the community. The community users can also post answers to questions that were previously submitted by other users. Therefore, over time, cQA services build up very large archives of previous questions and answers posted for those previous questions. Of course, the number of questions and answers that are archived depends on the number of users in the community, and how frequently the users access the cQA services.

In any case, there is typically a lag time between the time when a user in the community posts a question, and the time when other users of the community post answers to that question. In order to avoid this lag time, some cQA services automatically search the archive of questions and answers to see if the same question has previously been asked. If the question in found in the archives, then one or more previous answers can be provided, in answer to the current question, with very little delay. This type of searching for previous answers is referred to as “question search”.

By way of example, assume that a given question is “any cool clubs in Berlin or Hamburg?” A cQA service that has question search capability might return, in response to searching the questions in the archive, a previously posted question such as “what are the best/most fun clubs in Berlin?” which is substantially semantically equivalent to the input question, and one would expect it to have the same answers as in the input question.

The discussion above is merely provided for general background information and is not intended to be used as an aid in determining the scope of the claimed subject matter.

### SUMMARY

Another technique used to augment question search is referred to as question recommendation. Question recommendation is a technique by which a system automatically recommends additional questions to a user, based on an input question.

Questions submitted in a cQA service can be viewed as having a combination of a question topic and a question focus. Question topic generally presents a major context or constraint of a question while the question focus presents certain aspects of the question topic. For instance, in the example given above, the question topic is “Berlin” or “Hamburg” while the question focus is “cool club.” When users ask questions in a cQA service, it is believed that they usually have a fairly clear idea about the question topic, but may not be aware that there exists several other aspects around the question topic (several question foci) that may be worth exploring.

The present system graphs topic terms in stored cQA questions and also converts a submitted question into a graph of topic terms. Topic terms that correspond to a question topic are delineated from topic terms that correspond to question focus. New questions are recommended to the user based on a comparison between the topics of the new questions and the topic of the submitted question as well as the focus of the new questions and the focus of the submitted question.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates one or more question trees generated from a set of archived questions.

FIG. 2 is a block diagram of one illustrative embodiment of a question indexing system that indexes stored questions received by a community question and answering service.

FIG. 3 is a flow diagram illustrating one embodiment of the overall operation of the system shown in FIG. 2.

FIG. 4 is a flow diagram illustrating how topic terms are identified in the stored questions.

FIG. 5 is a flow diagram illustrating how a question tree is generated from a set of questions.

FIG. 6 is a block diagram illustrating one illustrative embodiment of a runtime system for recommending questions to a user.

FIG. 7 is a flow diagram illustrating one illustrative embodiment of the overall operation of the system shown in FIG. 6.

FIG. 8 is a flow diagram illustrating one illustrative embodiment of the operation of the system shown in FIG. 6 in calculating, ranking and outputting recommended questions based on an input question.

FIG. 9 is a block diagram of one illustrative computing environment.

### DETAILED DESCRIPTION

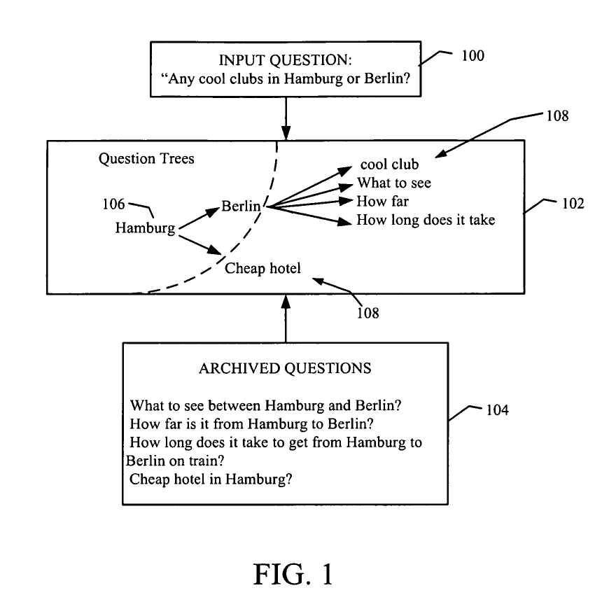

The present system receives a question in a community question and answering system from a user. The present system then divides the question into its topic and focus, and recommends one or more additional questions that reflect different aspects (or different areas of focus) for the topic in the question input by the user. This can be illustrated in more detail as shown in FIG. 1. FIG. 1 shows a question 100, q input by a user. The system uses question trees 102 generated from archived questions 104, which were previously submitted by community users in the community question answering system. The question trees 102 are used to generate one or more recommended questions q′ such that the questions 100, q and q′ reflect different aspects of the user's topic in its original question 100, q.

More specifically, the question 100 input by the user shown in FIG. 1 is “any cool clubs in Hamburg or Berlin?” The topic of such a question usually presents the major context or constraint of a question. In the example shown in FIG. 1, the topic is “Berlin” or “Hamburg”, which characterizes the user's broad topic of interest. The questions also generally have a focus which presents certain aspects (or descriptive features) of the question topic. In other words, the focus is a more specific item of interest, than the broad topic, represented in the user's question. In the example shown in FIG. 1, the focus is “cool clubs”. By accessing question trees 102, the present system substitutes the question focus in the question submitted by the user with one or more different aspects of interest, while maintaining the same topic.

In FIG. 1, the question trees (or question graph) 102, assumes that there exists a number of topic terms representing the input question 100, and a number of previously input questions, input by the community in a community question answering system. In the tree 102, the nodes that represent the topic of the question are expected to be closer to the root node than the nodes representing question focus. For instance, in the question trees 102, the root node is node 106 identifying the topic term “Hamburg”. The leaf nodes are illustratively shown at 108, and represent the portions of the question trees 102 that are furthest down the line of dependency in the trees. The question topics in tree 102 is assumed to be closer to root node 106 than to leaf nodes 108, while the question focus for the questions (or the particular aspects of the questions) are the leaf nodes 108, or nodes that are closer to the leaf nodes 108 than to the root node 106. Of course, nodes that lie equally between the root node and leaf nodes 108 may either be a question topic or a question focus.

The present system can recommend questions to the user by retaining the question topic nodes in tree 102, but by substituting different focus terms 108. In doing so, the present system identifies the focus of a question by beginning at root node 106 and advancing towards leaf nodes 108 and deciding where to make a cut in tree 102 that divides the question focus of the questions represented by the tree from the question topic represented by the tree.

To accomplish this, the present system first represents the archive questions 104 and the input question 100 as one or more question trees (or graphs) of topic terms. The topic terms are not to be confused with the question topic. Topic terms are simply terms in the question input by the user, or the archived questions, that are content words, as opposed to non-content words. The question topic, as discussed above, is the topic of the question, as opposed to the focus of the question. Therefore, in order to represent each of the questions as a tree or graph of topic terms, the system first builds a vocabulary of topic terms such that the vocabulary adequately models both the input question 100 and the archived questions 104. Given that vocabulary of topic terms, a question tree (graph) is constructed. A tree cut is then performed to divide the tree among its question foci and question topic. Then, different question focus terms are substituted for those submitted in the input question 100, and those questions are ranked. The highest ranked questions are output as recommended questions for the user.

Using the example shown in FIG. 1, dashed line 110 represents one illustrative cut of question tree 102. The nodes that lie above and to the left of dashed line 110 are nodes that correspond to the question topic, while the nodes that lie below and to the right of line 110 correspond to question focus. Based on this cut, the present system can recommend questions that have a question topic of Hamburg or Berlin but have a different focus. Some of those questions can be the archived questions 104.

Therefore, the system can generate recommended questions to be provided to the user such as “What to see between Hamburg and Berlin?” In that instance, the substitution of “what to see” is substituted for the focus “cool club”. Another recommended question might be “How far is it from Hamburg to Berlin?” In that instance, the focus “how far is it” is substituted for the focus “cool club”, etc. Given all of the various questions that could be recommended to the user, the system then ranks those questions, as is discussed below.

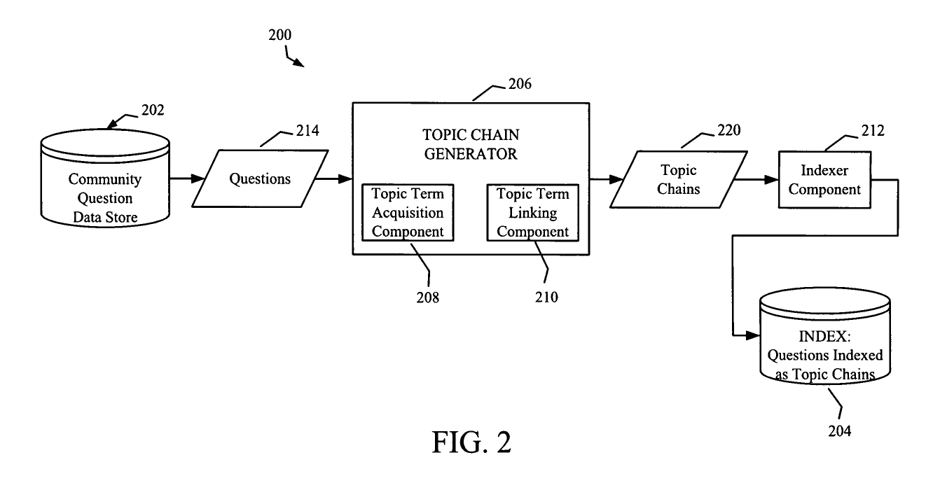

FIG. 2 is a block diagram of question indexing system 200 that is used to extract topic terms from archived questions in community question data store 202 and generate an index 204 of those questions, indexed by the topic terms. System 200 includes topic chain generator 206 which itself includes topic term extraction component 208 and topic term linking component 210. System 200 also includes indexer component 212.

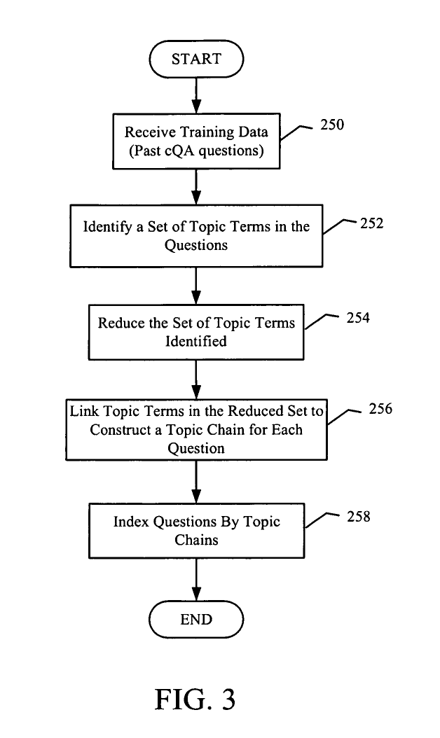

FIG. 3 is a flow diagram illustrating how questions from data store 202 are indexed. In brief, questions 214 are retrieved from data store 202, and topic terms are extracted from questions 214 and then linked together to form topic chains. The questions are then indexed in index 204 based on the topic chain generated for the questions.

More specifically, topic chain generator 206 first receives training data in the form of questions from community question data store 202. The training data questions 214 are illustratively questions which were previously submitted by a community of users in a given community question and answering system. This is indicated by block 250 in FIG. 3.

In order to extract topic terms from questions 214, topic chain generator 206 is a two-phase system which first extracts a list of topic terms from the questions and then reduces that set of topic terms to represent the topics more compactly. Topic term acquisition component 208 this first identifies the set of topics in the questions. This is indicated by block 252 in FIG. 3.

There are many different ways that can be used to identify topic terms in questions. For instance, in one embodiment, linguistic units, such as words, noun phrases, and n-grams can be used to represent topics. The topic terms for a given sentence illustratively capture the overall topic of a sentence, as well as the more specific aspects of that topic identified in the sentence or question. It has been found that words are sometimes too specific to outline the overall topic of sentences or questions. Therefore, in one embodiment, topic term acquisition component 208 considers noun phrases and n-grams (multiword units) as candidates for topic terms.

In order to acquire noun phrases from the input questions 214, component 208 identifies base noun phrases as simple and non-recursive noun phrases. In many cases, the base noun phrases represent holistic and non-divisible concepts within the question 214. Therefore, topic term acquisition component 208 extracts base noun phrases (as opposed to noun phrases) as topic term candidates. The base noun phrases include both multi-word terms (such as “budget hotel”, “nice shopping mall”) and named entities (such as “Berlin”, “Hamburg”, “forbidden city”). There are many different known ways for identifying base noun phrases in sentences or questions, and one way uses a unified statistical model that is trained to identify base noun phrases in a given language. Of course, other statistical methods, or heuristic methods, could be used as well.

Another type of topic term that is used by topic term acquisition component 208 is n-grams of words. There are also many ways for identifying n-grams by using natural language processing, which can be either statistical or heuristically based processing, or other processing systems as well. In any case, it has been found that a particular type of n-gram (wh-n-grams) are particularly useful in identifying topic terms in questions 214. Most meaningful n-grams are already extracted by component 208, once it has extracted base noun phrases. To complement the base noun phrase extraction, component 208 uses wh-n-grams, which are n-grams beginning with wh-words. For the sake of the present discussion, these include “when”, “what”, “where”, “why”, “which”, and “how”.

By way of example, Table 1 provides exemplary topic term candidates that are base noun phrases containing the word “hotel” and exemplary wh-n-grams containing the word “where”. It should be noted that the table does not include all the topic term candidates containing “hotel” or “where”, but only exemplary ones. The base noun phrases are listed separately from the wh-n-grams and the frequency of occurrence of each topic term, in the data store 202, is listed as well.

TABLE 1

| Type | Topic Term | Frequency |
|---|---|---|
| BaseNP | hotel | 3983 |
| | suite hotel | 3 |
| | embassy suite hotel | 1 |
| | nice suite hotel | 2 |
| | western hotel | 40 |
| | good western hotel | 14 |
| | inexpensive western hotel | 12 |
| | beachfront hotel | 5 |
| | good beachfront hotel | 3 |
| | great beachfront hotel | 3 |
| | nice hotel | 224 |
| | affordable hotel | 48 |
| WH-ngram | where | 365 |
| | where to learn | 6 |
| | where to learn computer | 1 |
| | where to learn Japanese | 1 |
| | where to buy | 5 |
| | where to buy ginseng | 1 |
| | where to buy insurance | 23 |
| | where to buy tea | 12 |

Having thus identified a preliminary set of topic terms (in block 252 in FIG. 3) topic term acquisition component 208 then reduces that set in order to represent the extracted topic terms more compactly, and also in order to enhance the reusability of the topic terms when applied to unseen data. In other words, the set of topic terms is reduced so that it is slightly more generalized so that it might apply more broadly to unseen data. Reducing the set of topic terms identified to generate a vocabulary of topic terms which adequately models both the input question and the questions in data store 202 is indicated by block 254 in FIG. 3.

To clarify this step, an example will be discussed. Assume that a topic term candidate containing the word “hotel” is that one in Table 2 which identifies “embassy suite hotel”. This topic term may be reduced to “suite hotel” because “embassy suite hotel” may be too sparse and unlikely to be hit by a new question posted by a user in the community question answering system. At the same time, it may be desirable to maintain “inexpensive western hotel” although “western hotel” is also one of the topic terms.

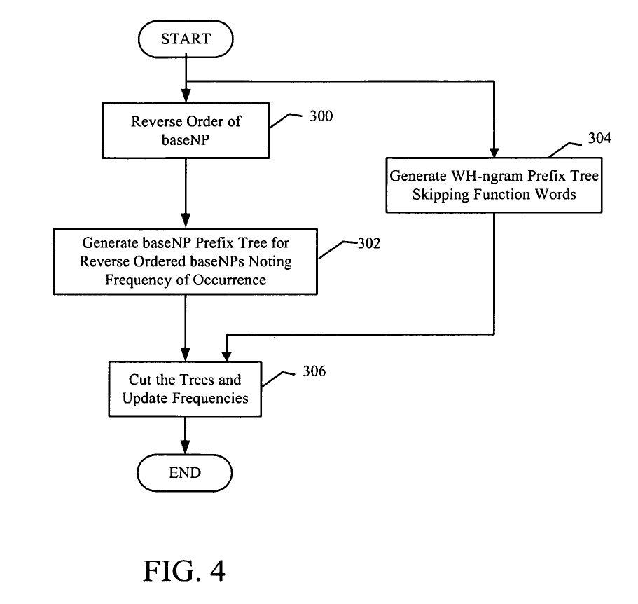

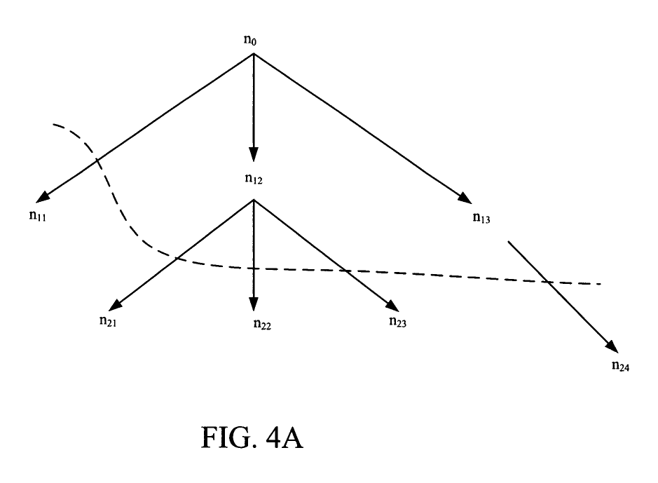

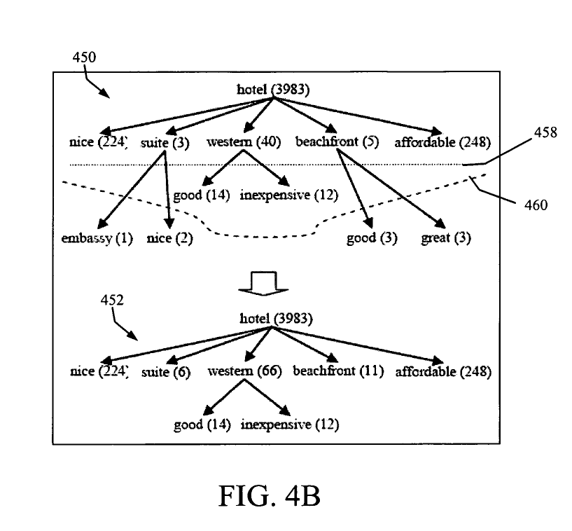

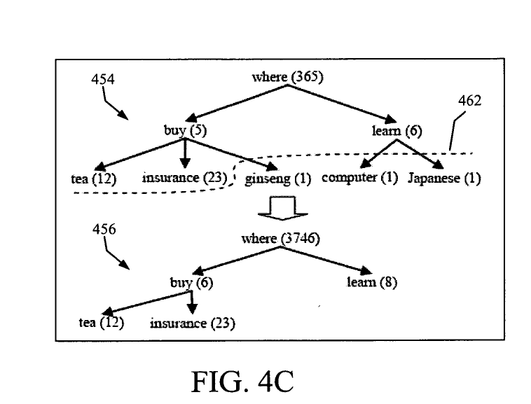

Reducing the set of topic terms is discussed in greater detail below with respect to FIG. 4.

Once the reduced set of topic terms has been extracted by component 208, topic term linking component 210 links the topic terms to construct a topic chain for each question 214. This is indicated by block 256 in FIG. 3. For instance, given the questions shown in FIG. 1, Table 2 identifies a list of topic chains for each of those questions.

TABLE 2

Hamburg → Berlin → cool club
Hamburg → Berlin → where to see
Hamburg → Berlin → how far
Hamburg → Berlin → how long does it take
Hamburg → cheap hotel

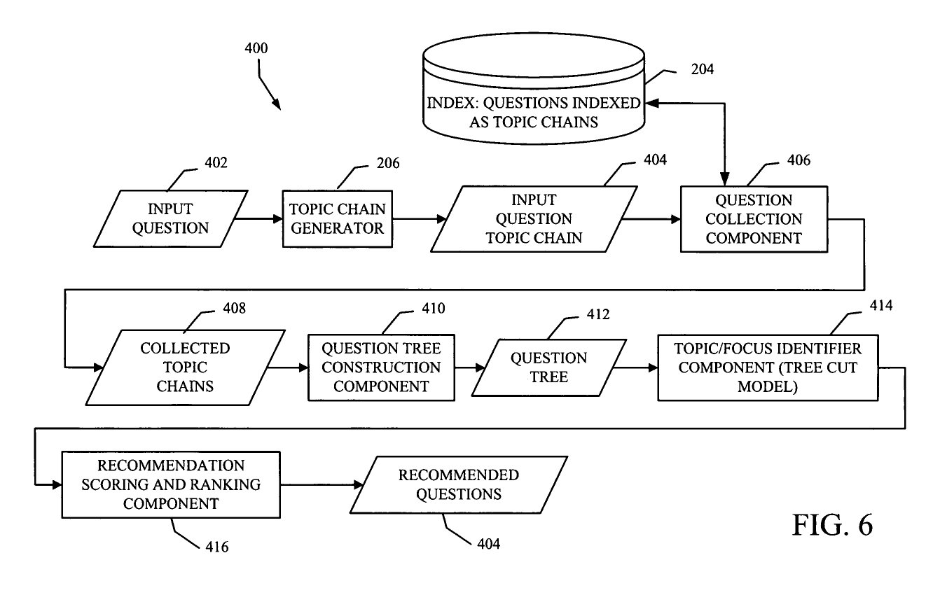

Topic chains are indicated by block 220 in FIG. 2. After topic chain generator 206 generates topic chains 220, they are provided to an indexer component 212 which indexes the questions by topic chains 220 and provides them to index 204. In one embodiment, the topic chains are indexed alphabetically, and by frequency, based on the root nodes in the topic chains, and then based on the dependent nodes (those nodes advancing from the root node to the leaf nodes). Indexing the questions by topic chains is indicated by block 258 in FIG. 3. The topic chains can then be used to recommend questions. Using the topic chains indexed in index 204 in order to generate recommended questions based on an input question, input by a community user, is described in more detail below with respect to FIGS. 6-8.

Reducing the topic terms (as briefly discussed above with respect to block 254 in FIG. 3) will now be discussed in more detail. It is assumed that a set of topic terms (such as those shown in Table 1) have been identified given a set of input questions. Formally, the reduction of topic terms can be described as a decision making process. Given a corpus of questions, a decision is made as to what topic terms are more likely applicable to unseen questions. Using model selection, a model is selected that best fits the given corpus and has good capability of generality. When using model selection, each operation that is used to reduce the topic terms results in a different model. Therefore, more or less generality can be achieved by implementing more topic term reduction steps, or fewer, respectively.

In order to perform reduction, a question tree is built (as discussed above with respect to FIG. 1) and then the tree is cut to divide the question tree between question topics and question aspects, or foci. In the exemplary embodiment discussed herein, the minimum description length (MDL) based tree cutting technique is used to cut the tree to perform model selection, although other techniques could be used as well. Therefore, prior to discussing the specifics of cutting the question tree, the MDL-based tree cut model is described briefly, for the sake of completeness. Formally, a tree cut model M can be represented by a pair of parameters that include a tree cut Γ and a probability parameter vector β of the same length. That is:

M=(Γ,Θ) Eq. 1

where Γ and Θ are defined as follows:

Γ=[C₁, C₂, . . . Cₖ], Θ=[p(C₁), p(C₂), . . . , p(Cₖ)] Eq. 2

where C₁, C₂, . . . Cₖ are classes determined by a cut in the tree and

$${\sum }_{i = 1}^{k} p ( {C}_{2} ) .$$

A “cut” in a tree identifies any set of nodes that define a partition of all the nodes, viewing each node as representing the set of child nodes, as well as itself. For instance, FIG. 4A represents a tree with nodes n₀-n₂₄. The first number in the subscript of the nodes represents the level of the tree where the node resides while the second number represents the node number within the level identified by the first number. FIG. 4A shows that a cut indicated by the dashed line in FIG. 4A corresponds to three classes: [n₀, n₁₁], [n₁₂, n₂₁, n₂₂, n₂₃], and [n₁₃, n₂₄].

A straight-forward way for determining a cut of the tree is to collapse nodes in the tree that occur less frequently in the training data into the parent of those nodes, and then updating the frequency of the parent node to include the frequency of the child nodes that are collapsed into it. For instance, node n₂₄ in FIG. 4A may be collapsed into node n₁₃. Then, the frequency count for node n₂₄ is combined with the frequency count of node n₁₃. Such a tree cut technique may rely heavily on manually tuned frequency thresholds. Therefore, in one embodiment, the present system uses the theoretically well-motivated tree cutting technique that is based on the known MDL principle. \hat{Θ}

The MDL principle is a principle of data compression and statistical estimation from information theory. Given a sample S and a tree cut Γ, maximum likelihood estimation is employed to estimate the parameters of the corresponding tree cut model \hat{M}=(Γ, \hat{Θ}) where \hat{Θ} denotes the estimated parameters.

According to the MDL principle, the description length L(\hat{M}, S) of the tree cut model \hat{M} and the sample S is the sum of the model description length L (Θ)), the parameter description length L (\hat{Θ}|Γ), and the data description length L(S|Γ, Θ). That is:

L(\hat{M},S)=L(Γ)+L(\hat{Θ}|Γ)+L(S|Γ,\hat{Θ}) Eq. 3

The model description length L(Γ) is a subjective quantity which depends on the coding scheme employed. In the present system, it is simply assumed that each tree cut model is equally likely, a priori. The parameter description length L (\hat{Θ}|Γ) is calculated as follows:

$$L ( \hat{Θ} \vert Γ ) = \frac{k}{2} \times log \vert S \vert \qquad Eq . 4$$

where the absolute value S denotes the sample size, k denotes the number of tree parameters in the tree cut model. That is k=the number of nodes in Γ−1.

The data description length L (S|Γ, \hat{Θ}) is calculated as follows:

$$\begin{matrix}L ( S \vert Γ , \hat{Θ} ) = - {\sum }_{n ∈ S} log \hat{p} ( n ) \\ where & Eq . 5 \\ \hat{p} ( n ) = \frac{1}{\vert C \vert} \times \frac{f ( C )}{\vert S \vert} & Eq . 6\end{matrix}$$

where f(C) denotes the total frequency of topic terms in class C in the sample S.

With the description length defined as in Eq. 3 above, a tree cut model is to be selected with the minimum description length and output as the result of reduction.

FIG. 4 is a flow diagram illustrating how a tree of topic terms extracted from a set of questions is constructed such that it can model the process of reducing topic terms, using MDL-based tree cut modeling.

In accordance with one embodiment, modifier portions of topic terms are ignored when reducing the topic term to another topic term. Therefore, the present system uses two types of reduction, the first being removing the prefix of base noun phrases, and the second being removing the suffix of wh-n-grams. A data structure referred to as a prefix tree (also sometimes referred to as trie) is used for representing the base noun phrases and wh-n-grams.

The two types of reduction correspond to two types of prefix trees, namely a prefix tree of reversely ordered base noun phrases and a prefix tree of wh-n-grams. In order to generate the prefix tree for base noun phrases, the order of the terms (or words) in the extracted base noun phrases is first reversed. This is indicated by block 300 in FIG. 4. For instance, if the topic term is “beachfront hotel”, the words in the topic term are reversed to “hotel beachfront”.

FIG. 4B has a first prefix tree portion 450 and a second tree prefix portion 452. The first prefix tree portion 450 is simply the prefix tree constructed by topic term acquisition component 208 (shown in FIG. 2) after the order of the terms in the base noun phrase topic terms are reversed. The numbers in parentheses in tree 450 illustrate the frequencies of occurrence of the corresponding topic terms in the training data (or community questions 214 retrieved from data store 202 in FIG. 2). Specifically, for instance, the node denoted by “beachfront (5)” means that the frequency of “beachfront hotel” is 5. This does not include the frequency of “good beachfront hotel” and that of “great beachfront hotel”, as those frequencies are broken out in separate nodes in tree 450. Generating the base noun phrase prefix tree for reverse ordered base noun phrases, noting the frequency of occurrence of the base noun phrases, is indicated by block 302 in FIG. 4B.

FIG. 4C shows a first prefix tree 454 and a second prefix tree 456. Trees 454 and 456 are prefix trees generated from the wh-n-grams extracted from questions 214 in data store 202. Those specific wh-n-grams shown in FIG. 4C are those found in Table 2. It can be seen that the functional words such as “to” and “for” are skipped when the wh-n-grams are fed into the prefix tree. In prefix tree generating techniques where the root node is required to be associated with an empty string, the root node is simply ignored. Generating the wh-n-gram prefix tree, skipping function words, is indicated by block 304 in FIG. 4. In one embodiment, this can be done in parallel with the processing in blocks 300 and 302, or in series with it.

Once prefix trees 450 and 454 are generated, and then a tree cut technique is used for selecting the best cut of the tree in order to reduce the topic terms to a desired level. As discussed above, in one embodiment, the MDL-based tree cut principle is used for selecting the best cut. Of course, a prefix tree can have a plurality of different cuts, which correspond to a plurality of different choices of topic terms.

In FIG. 4B, dotted line 458 and dashed line 460, each represent two of the possible cuts of tree 450. The selection given by the MDL-based tree cut technique is the cut indicated by dashed line 460, in the example being discussed. This results in the new tree 452 shown at the bottom of FIG. 4B. In the new tree 452, the topic terms “embassy” and “nice” are combined into the parent node “suite”. The frequencies associated with both “embassy” and “nice” are combined into the frequency indicator for the node “suite”, such that the node “suite” now has a frequency of 3+1+2=6. Similarly, the frequency of the node “beachfront” is updated to include the frequencies associated with the original leaf nodes “good” and “great”. This effectively reduced the number of topic terms represented by tree 50 from containing “embassy suite hotel”, “nice suite hotel”, “good beachfront hotel”, and “great beachfront hotel” to the terms “suite hotel”, and “beachfront hotel” as represented by tree 452.

Similarly, in one embodiment, the MDL-based tree cut technique cuts tree 454 in FIG. 4C along dashed line 462. This yields the tree 456 that represents a reduced set of topic terms.

Performing the tree cut and updating the frequency indicators is illustrated by block 306 in FIG. 4.

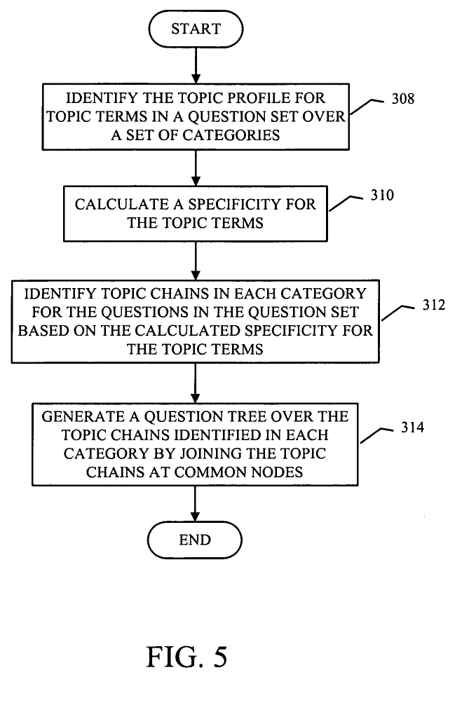

FIG. 5 is a flow diagram illustrating, in greater detail, how question trees, such as tree 102, can be constructed. The question tree includes all of the topic terms occurring in either the input question, input by the user, or the questions 214 from question data store 202. Such question trees are constructed from a collection of questions.

In order to identify the set, or collection of questions used to construct the tree, a topic profile Θₜ is first defined. The topic profile Θₜ of a topic term t in a categorized text collection is a probability distribution of categories {p(c|t)}_{cεC} where C is a set of categories.

$$p ( c \vert t ) = \frac{count ( c , t )}{{\sum }_{c ∈ C} count ( c , t )} \qquad Eq . 7$$

where count(c,t) is the frequency of the topic term t within the category c. Then,

$${\sum }_{c ∈ C} p ( c \vert t ) = 1.$$

By categorized questions, it is meant the questions that are organized in a tree of taxonomy. For example, in one embodiment, the question “How do I install my wireless router” is categorized as “Computers and Internet Computer→Networking”.

Identifying the topic profile for topic terms in a question set over a set of categories is indicated by block 308 in FIG. 5.

Next, a specificity for the topic terms is defined. The specificity s(t) of a topic term t is the inverse of the entropy of the topic profile Θₜ. More specifically:

$$s ( t ) = 1 / - {\sum }_{c ∈ C} P ( c \vert t ) log p ( c \vert t ) + ɛ \text{)} \qquad Eq . 8$$

where ε is a smoothing parameter used to cope with the topic terms whose entropy are 0. In practice, the value of ε can be empirically set to a desired level. In one embodiment, it is set as 0.001.

Specificity represents how specific a topic term is in characterizing information needs of users who post questions. A topic term of high specificity (e.g., Hamburg, Berlin) usually specifies the question topic corresponding to the main context of a question. Thus, a good question recommendation is required to keep such a question topic as much as possible so that the recommendation can be around the same context. A topic term of low specificity is usually used to represent the question focus (e.g., cool club, where to see) which is relatively volatile.

Calculating the specificity of the topic terms is indicated by block 310 in FIG. 5.

After all of the topic terms have had a topic profile and specificity calculated for them, topic chains are identified in each category for the questions in the question set, based on the calculated specificity for the topic terms. A topic chain q^{c} of a question q is a sequence of ordered topic terms t1→t2→ . . . →tₘ such that

1) tᵢ is included in q, 1≦i≦m;
2) s(tₖ)>s(t₁), 1≦k≦1≦m.
For example, the topic chain of “any cool clubs in Berlin or Hamburg?” is “Hamburg→Berlin→cool club” because the specificities for “Hamburg”, “Berlin”, and “cool club” are 0.99, 0.62, and 0.36, respectively.

Identifying the topic chains for the topic terms is indicated by block 312.

Once the topic chains have been identified for the set of questions, then a question tree for the set of questions can be generated.

A question tree of a question set Q={qᵢ}ᵢ₌₁^{N} is a prefix tree built over the topic chains Qc={qᵢ^{c}}ᵢ₌₁^{N} of the question set Q. Clearly, if a question set contains only one question, its question tree will be exactly the same as the topic chain of the question.

For instance, the topic chains associated with the questions in FIG. 1 are shown in Table 2 above.

From this description, it can be seen that the question tree 102 in FIG. 1 is actually formed of a plurality of different topic chains. The topic chains are words connected by arrows, and the direction of the arrows is based on the calculation of specificity for each topic term in the chain. The frequency counts in the tree represent the number of times the topic terms have been seen in that position in a topic chain in the data from which the question tree was calculated. Generating a question tree over the topic chains identified in each category is performed by joining the topic chains at common nodes, and this is indicated by block 314 in FIG. 5.

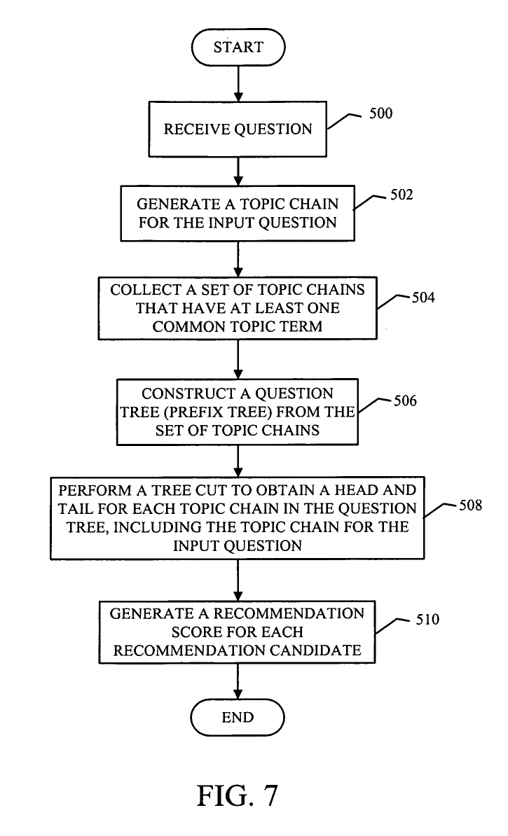

FIG. 6 is a block diagram of one illustrative runtime system 400 that is used to receive an input question 402 from a user and generate a set of ranked, recommended questions 404, by accessing the questions indexed by topic chains in index 204. System 400 thus first receives input question 402 input by a community user in a community question answering system. This is indicated by block 500 in FIG. 7. Topic chain generator 206 can be the same topic chain generator as shown in FIG. 2, or a different one. In the embodiment discussed herein, it is the same component. Topic chain generator 206 thus generates a topic chain for input question 402. The input question and the generated topic chain 404 are then output to question collection component 406. Topic chain generator 206 generates the topic chain as discussed above with respect to FIG. 2. Generating a topic chain for the input question is indicated by block 502 in FIG. 7.

The topic chain generated for the input question is used by question collection component 406 to identify topic chains in index 204 that have a similar root node to the topic chain generated for input question 402. More specifically, the topic terms of low specificity in the topic chains in index 204 and the topic chain for input question 402 are usually used to represent the question focus, which are relatively volatile. These topic terms are discriminated from those of high specificity and then suggested as substitutions.

For instance, recall that the topic terms in the topic chain of a question are ordered according to their specificity values calculated above with respect to Eq. 8. A cut of a topic chain thus gives a decision which discriminates the topic terms of low specificity (representing question focus) from the topic terms of high specificity (representing question topic). Given a topic chain of a question where the topic chain consists of M topic terms, there exists M−1 possible cuts. Each possible cut yields one kind of suggestion or substitution.

One method for recommending substitutions of topic terms (in order to generate recommended questions) is simply to take the M−1 cuts and then, on the basis of them, suggest M−1 kinds of substitutions. However, such a simple method can complicate the problem of ranking recommendation candidates (for recommended questions) because it introduces a relatively high level of uncertainty. Of course, if this level of uncertainty is acceptable in the ranking process, then this method can be used.

In another embodiment, the MDL-based tree cut model is used for identifying a best cut of a topic chain. Given a topic chain q^{c} of a question q, a question tree is constructed of related questions as follows. First, a set of topic chains Q_{c}={qᵢ^{c}}ᵢ₌₁ⁿ is identified (as represented by block 408 in FIG. 6) such that at least one topic term occurs in both q^{c} and qᵢ^{c}. Then, a question tree 412 is constructed by question tree construction component 410 from the set of topic chains Q^{c}∪{q^{c}}. Collecting the set of topic chains that have at least one common topic term is indicated by block 504 in FIG. 7, and constructing the question tree from the set of topic chains is indicated by block 506 in FIG. 7.

Once the question tree 412 is generated by component 410, the topic/focus identifier component (which can be implemented as a MDL-based tree cut model) 414 performs a tree cut in the tree. Component 414 obtains a best cut of the question tree, which also gives a cut for each topic chain in the question tree, including q^{c}. In this way, the best cut is obtained by observing the distribution of topic terms over all the potential recommendations (all the questions in index 204 that are related to the input question 402), instead of only the input question 402.

A cut of a given topic chain q^{c} separates the topic chain into two parts: the head and the tail. The head (denoted as H(q^{c}) is the sub-sequence of the original topic chain q^{c} before the cut (upstream of the cut) in the topic chain. The tail portion (denoted as T(q^{c})) is the sub-sequence of the original topic chain q^{c} after the cut (downstream of the cut) in the topic chain. Therefore, q^{c}=H(q^{c})→T(q^{c}).

Performing a tree cut to obtain a head and tail for each topic chain in the question tree, including the topic chain for the input question, is indicated by block 508 in FIG. 7.

By way of example, one of the topic chains represented by question trees 102 in FIG. 1 includes the topic term “Hamburg or Berlin how far” based on the cut 110, the head includes the terms “Hamburg” and “Berlin” and the tail includes the terms “how far”. Therefore, the tail can be substituted with other terms in order to recommend additional questions to the user.

In order to decide which questions to recommend to the user, component 414 calculates a recommendation score r(\tilde{q}|q) for each of the substitution candidates (or recommendation candidates) represented by the other leaf nodes 108, as indicated by block 510 in FIG. 7. The recommendation score is defined over the input question 402, q, and a recommendation candidate \tilde{q}. Given q_{\tilde{1}} and q_{\tilde{2}} (both of which are recommendation candidates for the input question q) q_{\tilde{1}} is the better recommendation for q than q_{\tilde{2}} if r (q_{\tilde{1}}|q)<r (q_{\tilde{2}}|q).

Given that the topic chain of an input q 402 is separated into its head and tail as follows: q^{c}=H(q^{c})→T(q^{c}) by a cut, and given that the topic chain of a recommendation candidate \tilde{q} is separated into a head and tail as well, \tilde{q}^{c}=H(\tilde{q}^{c})→T(\tilde{q}^{c}), the recommendation score r(q, \tilde{q}) will satisfy the following with respect to specificity and generality. First, the more similar that the head of q^{c}(i.e., H(q^{c})) is to the head of the T(q^{c})

recommendation \hat{q}^{c}(i.e., H(\tilde{q}^{c})), then the greater is the recommendation score r (\tilde{q}|q). Similarly, the more similar that the tail T(q^{c}) is to the tail of the recommendation T(q^{c}) then the less the recommendation score r (\tilde{q}|q).

These requirements with respect to specificity and generality, respectively, help to ensure that the substitutions given by the recommendation candidates focus on the tail part of the topic chain, which provides users with the opportunity of exploring different question focus around the same question topic. For instance, again using the example questions shown in FIG. 1, the user might be able to explore the “where to see” or “how far” as the question focus instead of “cool club”, but all will be centered around the same question topic (e.g., Hamburg, Berlin). In order to better define the recommendation score, a similarity score sim(q₂^{c}|q₁^{c}) is defined for measuring the similarity of the topic chain q₁^{c} to q₂^{c}, as follows:

$$sim ( {q}_{2}^{C} \vert {q}_{1}^{C} ) = \frac{1}{\vert {q}_{1}^{C} \vert} {\sum }_{{t}_{1} ∈ {q}_{1}^{C}} s ( {t}_{1} ) \cdot {max}_{{t}_{2} ∈ {q}_{2}^{C}} P M I ( {t}_{1} , {t}_{2} ) \qquad Eq . 9$$

where |q₁^{c}| represents the number of topic terms contained in q₁^{c}; and
PMI(t₁,t₂) represents the pointwise mutual information of a pair of topic terms t₁ and t₂.

According to Eq. 9, the similarity between topic chains is basically determined by the associations between consistent topic terms. The PMI values of individual pairs of topic terms in Eq. 9 are weighted by the specificity of topic terms occurring in q₁^{c}. It should be noted that the similarity defined is asymmetric. Having the similarity defined, the recommendation score r(\tilde{q}|q) can be defined as follows, in order to meet all of the constraints discussed above:

r(\tilde{q}|q)=λ·sim(H(\tilde{q}^{c})|H(q^{c}))−(1−λ)·sim(T(\tilde{q}^{c})|T(q^{c}) Eq. 10

Eq. 10 balances between the two requirements of specificity and generality in a way of linear interpolation. The higher value of λ implies that the recommendations tend to be similar to the input question 402. The lower value of λ encourages the recommended questions to explore the question focus that is different from that in the queried question 402.

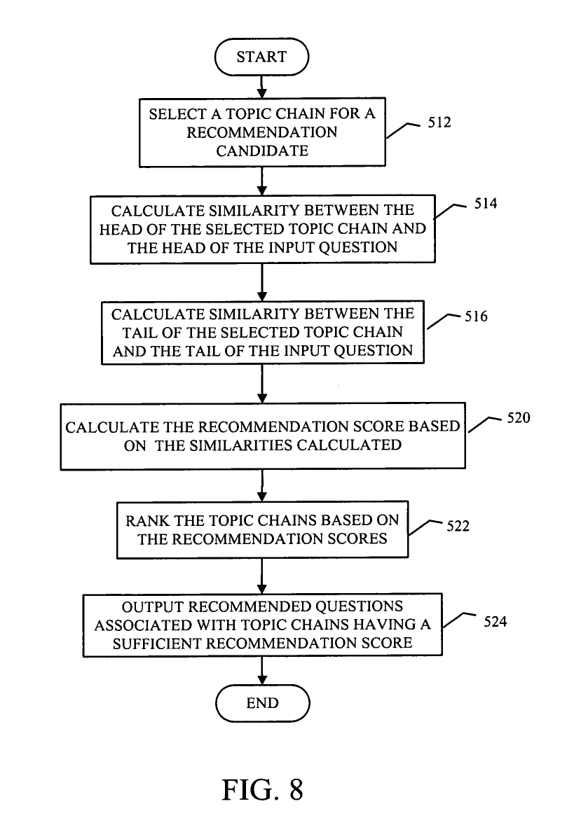

To calculate the scores, component 416 first selects a topic chain as a recommendation candidate. This is indicated by block 512 in FIG. 8. Component 416 then calculates the similarity between the head of the selected topic chain and the input question. This is indicated by block 514 in FIG. 8 and is indicated by the first term in Eq. 10. Then, component 416 calculates a similarity between the tail of the selected topic chain and the tail of the input question 402. This is indicated by block 516 in FIG. 8 and is indicated by the second term in Eq. 10.

Recommendation scoring and ranking component 416 thus generates the recommendation score for each of the recommendation candidates based on the similarities calculated. This is indicated by block 520 in FIG. 8.

Once component 416 generates the recommendation score for the recommendation candidates, the topic chains in each of the recommendation candidates can be ranked based on the recommendation scores calculated. This is indicated by block 522 in FIG. 8. Having calculated the recommendation score for each recommendation candidate, component 416 outputs the recommended questions 404 associated with topic chains having a sufficient recommendation score. This is indicated by block 524. Of course, the questions associated with the top N recommendation scores can be output, or all questions associated with a recommendation score that is above a given threshold can be output, or any other techniques can be used for identifying questions that are to be actually recommended to the user.

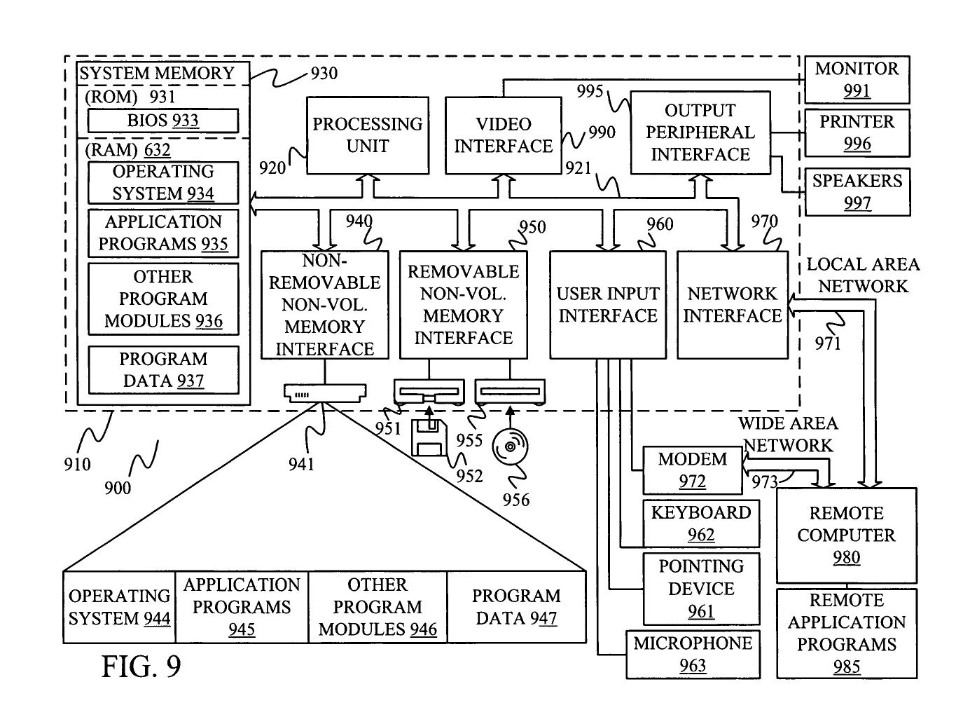

FIG. 9 illustrates an example of a suitable computing system environment 900 on which embodiments may be implemented. The computing system environment 900 is only one example of a suitable computing environment and is not intended to suggest any limitation as to the scope of use or functionality of the claimed subject matter. Neither should the computing environment 900 be interpreted as having any dependency or requirement relating to any one or combination of components illustrated in the exemplary operating environment 900.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 9, an exemplary system for implementing some embodiments includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. The systems shown in FIGS. 2 and 6 can be stored in other program modules 936 or elsewhere, including being stored remotely.

FIG. 9 shows the clustering system in other program modules 946. It should be noted, however, that it can reside elsewhere, including on a remote computer, or at other places.

A user may enter commands and information into the computer 910 through input devices such as a keyboard 962, a microphone 963, and a pointing device 961, such as a mouse, trackball or touch pad. Other input devices (not shown) may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections to one or more remote computers, such as a remote computer 980. The remote computer 980 may be a personal computer, a hand-held device, a server, a router, a network PC, a peer device or other common network node, and typically includes many or all of the elements described above relative to the computer 910. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on remote computer 980. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of recommending additional questions based on an input question to a question answering system, comprising:
dividing the input question into a question topic and a question focus;
accessing an index of questions to identify stored questions having a similar question topic to the input question, but different question focus from the input question;
generating recommended questions by substituting the question focus for the identified stored questions for the question focus of the input question; and
outputting the recommended questions as the additional questions.

2. The method of claim 1 wherein dividing the input question comprises:
identifying topic terms in the input question; and
generating a topic chain by linking the topic terms to one another based on a specificity of each of the topic terms.

3. The method of claim 2 wherein, in the index of questions, the stored questions are indexed by topic chains generated for each of the stored questions and wherein accessing the index comprises:
identifying topic chains in the index that have topic terms with highest specificity that are the same as topic terms in the topic chain for the input question that has a highest specificity.

4. The method of claim 3 wherein dividing the input question comprises:
constructing a question tree from the topic chains identified in the index and the topic chain for the input question; and
performing a tree cut on the question tree to divide the topic terms in the topic chains used to construct the question tree into topic terms that represent question topic and question focus for the input question and stored questions represented by the topic chains used to construct the question tree.

5. The method of claim 4 wherein generating recommended questions comprises:
forming the recommended questions using the topic terms representing the question topic of the input question but using topic terms representing the question focus of the stored questions.

6. The method of claim 5 wherein generating recommended questions comprises:
generating a recommendation score for each recommended question and wherein outputting the recommended questions comprises outputting only recommended questions having a sufficient recommendation score.

7. The method of claim 6 wherein performing a tree cut divides the topic chains used to construct the question tree into head portions and tail portions and wherein generating a recommendation score comprises:
calculating a similarity between the head portion of each topic chain corresponding to a stored recommended question with the head portion of the topic chain generated for the input question; and
calculating a similarity between the tail portion of each topic chain corresponding to a stored recommended question with the tail portion of the topic chain generated for the input question.

8. The method of claim 7 wherein outputting only recommended questions having a sufficient recommendation score comprises:
outputting a recommended question only if it has a recommendation score indicating the head portion of its corresponding topic chain is sufficiently similar
to the head portion of the topic chain for the input question and indicating that the tail portion of its corresponding topic chain is sufficiently dissimilar to the tail portion of the topic chain for the input question.

9. The method of claim 3 and further comprising:
generating the index by, for each stored question to be indexed, extracting topic terms from the question;
calculating a specificity for each topic term extracted;
linking the topic terms to one another in order of the calculated specificity to obtain a topic chain for the question; and
indexing the question based on the topic chain.

10. The method of claim 9 wherein extracting the topic terms comprises:
identifying as topic terms base noun phrases and wh-n-grams in the question.

11. The method of claim 9 wherein extracting topic terms comprises:
extracting a set of topic terms for all of the questions to be indexed; and
reducing the set of topic terms to a subset of topic terms more general that the set of topic terms.

12. The method of claim 4 wherein constructing a question tree comprises:
constructing a prefix tree using the topic terms in the topic chains identified in the index and the topic chain for the input question.

13. A system for recommending questions to a user of a community based question answering system, comprising:
an indexing system configured to generate an index of previously asked questions comprising:
a topic chain generator configured to generate a topic chain for each previously asked question to be indexed, each topic chain being a linked set of topic terms, linked in an order based on a specificity of the topic terms occurring in the previously asked question being indexed;
an indexing component configured to index the previously asked questions to be indexed based on the topic chains;
a question answering system configured to recommend questions based on an input question, comprising:
a question collection component configured to identify a set of topic chains in the index based on a topic chain generated for the input question;
a topic and focus identifier component configured to identify topic terms corresponding to question topic and question focus in the topic chains identified in the index and the topic chain for the input question; and
a recommendation component configured to generate and output recommended questions by substituting the topic terms corresponding to question focus in the topic chains identified in the index, for the topic terms corresponding to question focus in the topic chain for the input question.

14. The system of claim 13 wherein the topic chain generator is configured to generate the topic chain for the input sentence.

15. The system of claim 13 wherein the topic chain generator comprises:
a topic term acquisition component configured to extract topic terms from a question; and
a topic term linking component configured to calculate a specificity measure for each topic term and to link the topic terms extracted from a question to one another in an order based on a value of the specificity measure.

16. The system of claim 15 wherein the question answering system comprises:
a question tree construction component configured to construct a question tree from the set of topic chains identified; and
wherein the topic and focus identifier component comprises a tree cut component configured to cut the question tree to divide the topic chains used to construct the question tree into topic and focus portions.

17. The system of claim 16 wherein the recommendation component is configured to generate a recommendation score for each topic chain identified based on how similar the topic and focus portions are to the topic and focus portions of the topic chain for the input question.

18. The system of claim 17 wherein the recommendation score for an identified topic chain increases as a similarity of the topic portions of the identified topic chain and the topic chain for the input question increases and as a similarity of the focus portions of the identified topic chain and the topic chain for the input question decreases.

19. A computer readable storage medium having computer executable instructions encoded thereon which, when executed by a computer, cause the computer to recommend additional questions to a user of a community-based question answering system by performing steps of:
generating topic chains of linked topic terms for each of a plurality of stored questions;
generating a topic chain for the input question;
identifying a set of topic chains for the stored questions based on the topic chain for the input question;
building a question tree using the identified set of topic chains and the topic chain for the input question;
dividing the question tree to identify topics and foci in the topic chains used to construct the question tree; and
generating recommended questions by substituting the foci of the topic chains in the identified set of topic chains for the focus of the topic chain for the input question; and
outputting the recommended questions if the substituted foci are sufficiently dissimilar from the focus of the topic chain for the input question.

20. The computer readable medium of claim 19 wherein generating topic chains comprises:
extracting topic terms from questions previously asked in the community-based question answering system;
calculating a specificity for each topic term; and
linking the topic terms for each question based on the specificity.
